(19) United States
(12) Patent Application Publication
(10) Pub. No.: US 2018/0186382 A1
(43) Pub. Date: Jul. 5, 2018

(54) METHOD FOR THE ANTICIPATORY STARTING OF A HEAT ENGINE

(71) Applicant: Nissan Motor Co., Ltd., Yokohama-shi, Kanagawa (JP)

(72) Inventors: Florent LE CAM, Lardy (FR); Frédéric ROUDEAU, Vitry Sur Seine (FR)

(21) Appl. No.: 15/740,201

(22) PCT Filed: Jan. 14, 2016
(86) PCT No.: PCT/FR2016/050060

§ 371 Date: Dec. 27, 2017

(30) Foreign Application Priority Data
Jul. 7, 2015 (FR) 1556428

(51) Int. Cl. B60W 50/00; B60W 10/06; B60W 20/10; B60W 50/06

(52) U.S. Cl. CPC B60W 50/0097; B60W 10/06; B60W 20/10; Y10S 903/903; B60W 2520/105; B60W 2540/10; B60W 2710/06; B60W 50/06

(57) ABSTRACT

A method is provided for the anticipatory starting of a heat engine in a hybrid power train that includes at least a heat engine, a traction electric machine and an automatic transmission transmitting the drive power to the wheels of the vehicle in at least one initial state of the drive train of same in which the traction machine alone provides the traction of the vehicle and the heat engine is switched off, and at least one other target state in which the heat engine provides tractive power. The method involves sending, to the heat engine, an anticipatory starting request depending on the longitudinal acceleration of the vehicle and the starting time of same, before each change of state of the drive train between an initial state not requiring a started heat engine, and a target state requiring same to be started.

### CROSS-REFERENCE TO RELATED APPLICATIONS

This application is a U.S. National stage application of International Application No. PCT/FR2016/050060, filed on Jan. 14, 2016, which claims priority to French Patent Application No. 1,556,428, filed on Jul. 7, 2015.

### BACKGROUND

### Field of the Invention

The present invention relates to the control of a hybrid powertrain, comprising at least a heat engine and an electrical traction machine, and an automatic transmission connected to the wheels of the vehicle. More precisely, it concerns a method for the anticipatory starting of the heat engine in a hybrid powertrain comprising at least a heat engine, an electrical traction machine, and an automatic transmission which transmits the motive power to the wheels of the vehicle in at least an initial state of its drive train in which the electrical traction machine provides the vehicle traction on its own and the heat engine is stopped, and in at least another target state in which the heat engine provides traction power.

### Background Information

The powertrain of a motor vehicle equipped with an automatic transmission has a certain number of drive train states (ECC), defined by specific combinations of speed reducers, couplers and power modules available in the vehicle. One aim of the transmission control system is to put the powertrain in the optimal drive train state in all circumstances, regardless of the running conditions. The control constraints for providing the desired behavior include the limiting of noise and vibration (or NVH, standing for “Noise Vibration and Harshness”), the reliability limits of the mechanical components, and the optimization of performance (acceleration reserve, driver demand, etc.). Finally, in a hybrid vehicle, which by definition comprises at least two motive power sources, including a heat engine, the drive train can usually have at least one state in which the heat engine is not needed, and is often stopped, to limit fuel consumption.

When the drive train changes from a state in which it is stopped to a state in which it is used to provide, or contribute to, the traction of the vehicle and to meet the acceleration request, it does not start instantaneously. There is a delay between the selection of a new target state and the availability of the heat engine, due to its starting time.

FIG. 1 shows the possible differences in most cases between the maximum force envelopes of the drive train states of the same transmission, as a function of the speed of a vehicle. In this example, the force available to the wheel is much smaller in a first state, which does not require the heat engine as a power source (the electric drive train state, ECC1), than in a second thermal or hybrid state ECC2. However, the ECC2 state is available only at speeds above the launch speed of the vehicle provided by ECC1, in other words when the heat engine may be coupled to the wheels without risk of stalling. The ECC1 state, which supplies a maximum force of purely electrical origin (ZEV) to the wheel, does not cover the whole of the maximum force envelope of the powertrain in hybrid or thermal mode.

When a change from an electrical state to a hybrid or thermal state is triggered to follow the development of the torque request at the wheel, the heat engine does not start instantaneously. The time for the change of state may then be so long that the new state exceeds its reliability limit, because its speed is too high to allow the coupling of the new state. This delays by the same length of time the provision of the torque desired by the driver.

The publication U.S. Pat. No. 7,407,026 discloses a way of sending an anticipatory starting request to the heat engine, by predicting a change of state of the drive train which requires the starting of the heat engine. This method consists in calculating the force available to the wheel without the heat engine at the instant when the engine would have started. The available force may then be compared with the force request at the wheel, which is assumed to be constant.

### SUMMARY

It has been discovered that this above mentioned method cannot operate unless the transmission has only one state of the electric drive train. Moreover, it does not allow for any variation in the power of the electrical machine in this state. It causes the heat engine to start when required, but cannot minimize the delay between the selection of a hybrid or thermal state and the availability of the heat engine for the execution of the transition and the provision of the torque required at the wheel.

The present invention is intended to achieve this objective.

For this purpose, it proposes to send an anticipatory starting request to the heat engine, based on the longitudinal acceleration of the vehicle and its starting time, before each change of state of the drive train between an initial state in which the heat engine does not need to be started and a target state requiring the starting of the heat engine.

The method is based on a calculation of the force available to the wheel in the non-thermal or non-hybrid states at the predicted instant of starting of the heat engine, allowing for the starting time required, and the comparison of this force with the target force request at the wheel.

Preferably, the necessary conditions for an anticipatory request for starting the heat engine are that the engine is stopped, and that the powertrain is unable to meet the target force request at the wheel corresponding to the request of the driver and/or of driver assistance systems such as a speed controller.

This method can be used on all hybrid vehicles equipped with an automatic transmission, in which the powertrain has at least one drive train state which does not require a started heat engine and at least one state requiring the starting of the engine.

### BRIEF DESCRIPTION OF THE DRAWINGS

The present invention will be more readily understood from a perusal of the following description of a non-limiting embodiment of the invention, with reference to the appended drawings in which:

FIG. 1 shows the differences between two drive train states (ZEV, and thermal or hybrid),

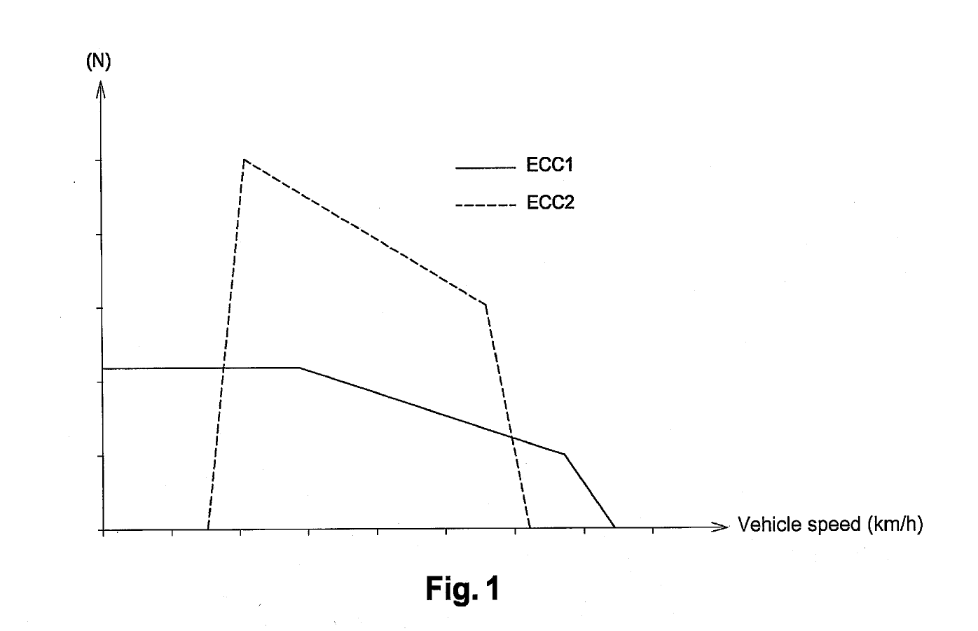

FIG. 2 is a flowchart of the strategy developed,

FIG. 3 is a first sub-flowchart F1 of the strategy developed, and

FIG. 4 is a second sub-flowchart F2 of the strategy developed.

### DETAILED DESCRIPTION OF EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

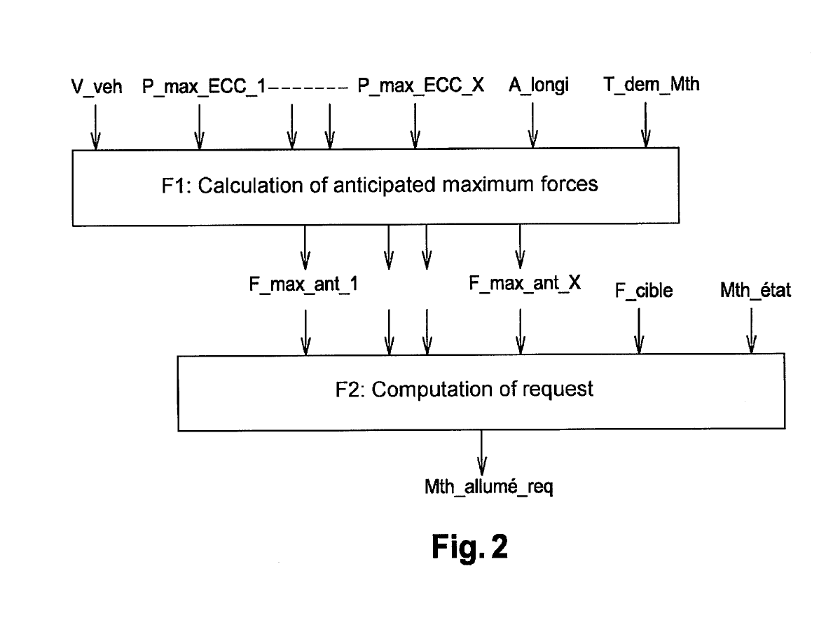

FIG. 2 shows all the data used in the first phase F1 of the method, for the calculation of the anticipated maximum forces:
V_veh: speed of the vehicle,
P_max_ECC_1 to P_max_ECC_X: maximum power available in the non-thermal or hybrid states ECC1 to ECCX of the drive train,
A_longi: the longitudinal acceleration of the vehicle,
T_dem_Mth: starting time of the heat engine, varying mainly as a function of the temperature of the heat engine, estimated for example on the basis of the cooling liquid temperature.

The anticipated maximum forces in each state, F_max_ant_1 to F_max_ant_X, are calculated in the first step F1. These are used in the second step F2, which also uses the target force request at the wheel F_cible, and the state of the heat engine Mth_état (stopped or running). The target force at the wheel F_cible is assumed to be constant until the starting of the heat engine. Step F2 computes the anticipatory starting request for the heat engine, Mth_allumé_req.

This method enables the starting of the heat engine to be anticipated in a hybrid powertrain comprising at least one heat engine, an electrical traction machine, and an automatic transmission which transmits the power of the heat engine and/or of the electrical machine to the wheels of the vehicle in at least an initial state of its drive train, in which the electrical traction machine provides the vehicle traction on its own and the heat engine is not started, and at least another target state in which the heat engine provides traction power.

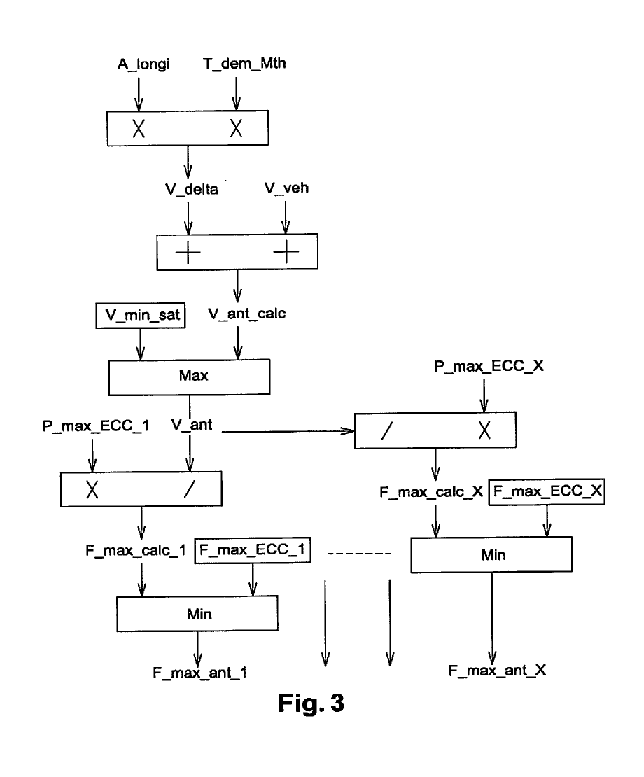

FIG. 3 details the first step F1. In this step, the maximum force at the wheel, F_max_calc_X, is calculated for each state X of the drive train, on the basis of the maximum power P_max_ECC_X in this state and the anticipated speed V_ant at the time of the actual starting of the engine. The anticipated speed V_ant is calculated on the basis of an estimated speed reached after the starting of the heat engine V_ant_calc, deduced from the estimated speed gain V_delta before the starting of the heat engine.

The anticipated speed (V_ant) is equal to the higher term of the calculated estimated speed (V_ant_calc) and a calibrated minimum speed (V_min_sat).

The speed gain (V_delta) is estimated on the basis of the longitudinal acceleration (A_longi) and the starting time of the heat engine (T_dem_Mth).

The various calculation sub-steps F1 are:

a) the calculation of the estimated speed gain during the starting of the heat engine V_delta, on the basis of the longitudinal acceleration A_longi and the starting time of the heat engine T_dem_Mth: V_delta=A_longi*T_dem_Mth;

b) the calculation of the estimated speed reached after the starting of the heat engine V_ant_calc, on the basis of the estimated speed gain V_delta and the vehicle speed V_veh: V_ant_calc=V_delta+V_veh;

c) the calculation of the saturated estimated speed reached V_ant on the basis of a calibrated minimum speed V_min_sat and of V_ant_calc: V_ant=MAX(V_min_sat; V_ant_calc);

d) for each state concerned, from 1 to X, the calculation of the maximum force at the wheel, F_max_calc_X, on the basis of the maximum power P_max_X and the saturated anticipated speed V_ant: F_max_calc_X=P_max_X/V_ant;

e) for each state concerned, from 1 to X, the calculation of the saturated maximum force at the wheel, F_max_ant_X, on the basis of F_max_calc_X and a calibrated maximum force, F_max_ant_X=MIN(F_max_ECC_X; F_max_calc_X).

The method is based on a calculation of the force available to the wheel in the non-thermal or non-hybrid states after the time T_dem_Mth required for the starting of the heat engine, and the comparison of this force with the target force request at the wheel.

The anticipated maximum force at the wheel in each state F_max_ant_X (equal to the saturated maximum force at the wheel calculated in e)) is equal to the smaller term of the calculated maximum force F_max_calc_X and a calibrated maximum force (F_max_ECC_X).

The calibrated minimum speed V_min_sat, introduced in c), makes it possible to avoid impossible operations in the execution of the strategy. The variable F_max_ant_X represents the anticipated maximum force in the state X. This is the maximum force that would be available at the end of the delay T_dem_Mth, if the heat engine was started immediately.

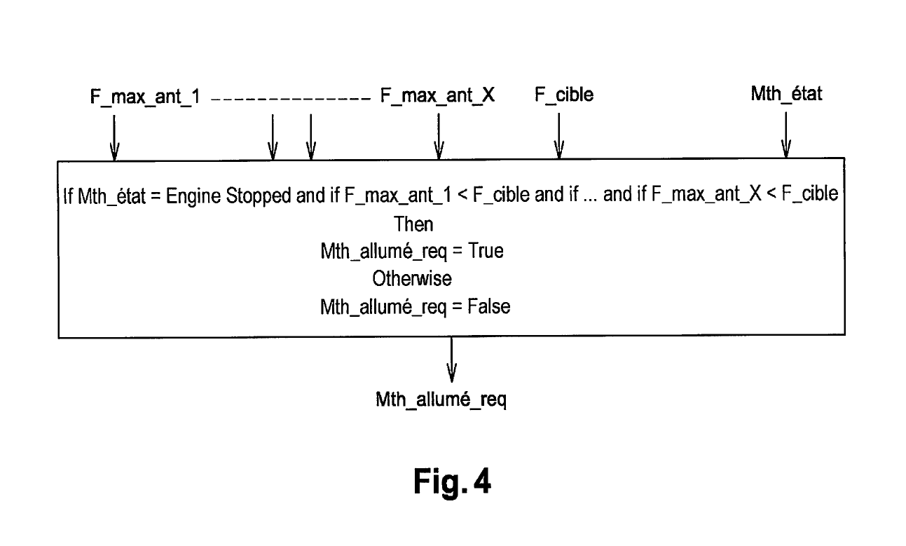

FIG. 4 shows the second step F2. This step consists in the computation of the anticipatory starting request for the heat engine, Mth_allumé_req. For this purpose, the anticipated maximum force at the wheel (F_max_ant_X) is determined in each state of the drive train, and is compared with the target force request at the wheel (F_cible).

The necessary conditions for the decision to start the heat engine by means of the command Mth_allumé_req are as follows:
engine stopped: Mth_état=Stopped,
purely electrical (non-hybrid and non-thermal) drive states in the drive train, incapable of supplying the target force requested at the wheel: F_max_ant_1<F_cible and . . . F_max_ant_X<F_cible.

This last condition implies that a hybrid or thermal state supplies more power than all the electrical states together. If both conditions are met, the starting request Mth_allumé_req becomes “true”. Otherwise, the request remains “false”. Ultimately, an anticipatory starting request Mth_allumé_req is sent to the engine on the basis of the longitudinal acceleration of the vehicle A_longi and its starting time T_dem_Mth, before each change of state of the drive train between an initial state in which the heat engine does not need to be started and a target state requiring the starting of the heat engine.

The proposed method has a number of advantages, including:
ease of implementation in a global transmission control strategy,
real-time execution, enabling allowance to be made for the variable parameters of the vehicle, such as the maximum powers in the drive train states, the acceleration of the vehicle, the road gradient, etc.,
potential application to all hybrid powertrain architectures having at least two drive train states, including one with the heat engine running and one with the heat engine stopped.

1. An anticipation method for anticipatory starting of a heat engine in a hybrid powertrain comprising at least the heat engine, a drive train, an electrical traction machine, and an automatic transmission which transmits a motive power to a wheel of a vehicle in at least an initial state of the drive train in which an electrical traction machine provides vehicle traction on its own and the heat engine is stopped, and in at least another target state in which the heat engine provides traction power, the anticipation method comprising:
sending an anticipated starting request to the heat engine based on a longitudinal acceleration of the vehicle and a starting time, before each change of state of the drive train between an initial state not requiring a started heat engine and a target state requiring the starting of the engine,
calculating a calculated maximum force available to the wheel in a non-thermal drive train state or non-hybrid drive train state after the starting time required for the starting of the heat engine, and on a comparison of the calculated maximum force with a target force request at the wheel corresponding to a request of at least one of the driver a driver assistance system.

2. The anticipation method as claimed in claim 1, wherein
necessary conditions for the triggering of the anticipatory starting request for starting the heat engine are that the heat engine is stopped, and that the powertrain is unable to meet the target force request at the wheel in the non-thermal and non-hybrid drive train states.

3. The anticipation method as claimed in claim 1, further comprising
assuming the target force request at the wheel is constant until the starting of the heat engine.

4. The anticipation method as claimed in claim 1, further comprising
determining an anticipated maximum force at the wheel is determined in each state of the drive train, and comparing the anticipated maximum force at the wheel with the target force request at the wheel.

5. The anticipation method as claimed in claim 2, wherein
the calculating of the calculated maximum force at the wheel for each state of the drive train, based on a maximum power in this state and an anticipated speed corresponding to a moment of actual starting of the heat engine.

6. The anticipation method as claimed in claim 4, wherein
the calculating of the calculated maximum force at the wheel for each state of the drive train, based on a maximum power in this state and an anticipated speed corresponding to a moment of actual starting of the heat engine, and
the maximum force at the wheel in each state is equal to the smaller term of the calculated maximum force and a calibrated maximum force.

7. The anticipation method as claimed in claim 1, further comprising
calculating an estimated speed reached after the starting of the heat engine based on an estimated speed gain during the starting of the heat engine.

8. The anticipation method as claimed in claim 5, wherein
the anticipated speed is equal to a higher term of a calculated estimated speed and a calibrated minimum speed.

9. The anticipation method as claimed in claim 7, further comprising
estimating a speed gain based on a longitudinal acceleration and the starting time of the heat engine.
